(19) United States
(12) Patent Application Publication
(10) Pub. No.: US 2025/0119417 A1
(43) Pub. Date: Apr. 10, 2025

(54) Method And System For Securely Communicating In A Networked System

(71) Applicant: Axiom Technologies LLC, Reston, VA (US)

(72) Inventors: Maxwell DOHERTY, Reston, VA (US); Jonathan Graham, Triangle, VA (US)

(21) Appl. No.: 18/905,227

(22) Filed: Oct. 3, 2024

Related U.S. Application Data
(60) Provisional application No. 63/629,953, filed on Oct. 6, 2023.

(51) Int. Cl. H04L 9/40; G06F 21/64

(52) U.S. Cl. CPC H04L 63/0807; G06F 21/64; H04L 63/166

(57) ABSTRACT

A method and system for accessing a protected web resource includes communicating, by a client device, a client request for accessing the protected web resource, intercepting the client request at a perimeter guard system, initiating a first session between the client device and an authentication server, authenticating the client device at the authentication server during the first session, in response to authenticating, associating an authentication token with a first cryptographic signature, communicating the authentication token to the client device, initiating a second session between the client device and the perimeter guard system using the authentication token and, based on the authentication token, allowing the client device to access the protected web resource.

### CROSS-REFERENCE TO RELATED APPLICATIONS

This application claims the benefit of U.S. Provisional Application No. 63/629,953, filed on Oct. 6, 2023. The entire disclosure of the above application is incorporated herein by reference.

### FIELD

The present disclosure relates to security in a networked system, and more particularly, to a method and system for mutual authentication in a networked system.

### BACKGROUND

This section provides background information related to the present disclosure which is not necessarily prior art.

Clients communicate with applications running on servers via a distributed communications network like the Internet or at a local area network scale. Securing the communication between clients and applications involves implementing various cybersecurity technologies that are implemented according to a security architecture. The architecture formally identifies vulnerabilities and measures to mitigate these vulnerabilities, which include a combination of technologies, processes, procedures, and personnel.

Contemporary security architectures prescribe a perimeter approach to protecting resources wherein an ensemble of cybersecurity products is integrated to segment network traffic, hosts, data, applications, and so forth. Several logical layers or zones may be used to segment resources based on trust, organizational construct, physical location, or any other variety of factors (logical and/or physical). Data flows via network transport between clients and applications. Perimeters that data transit through are controlled via rules/policies with the ultimate goal of separating requests into authorized (allowed to permeate) and unauthorized (blocked from permeating).

Applications expose functionality and data to clients. Clients can be any arbitrary device with connectivity to the network, so applications are dependent on technologies that allow them to identify the client. Identity can belong to individuals, devices, and/or any combination of the two. In the digital domain, it is impossible to tell who is who without somehow challenging an identity to prove who/what they are via authentication.

Authentication mechanisms allow individuals the chance to prove who they are so that an application can use a successfully proven identity to make access control and other decisions in the course of providing clients data and other functionality. Applications themselves may provide authentication functionality (design their own based on best practices or completely create their own) or trust another system to do it for them. Presumably, only the “real” entity who is associated with a digital identity can successfully authenticate, thus applications granting access implicitly trust identities once presented indefinitely (without re-challenge). Because of the perimeter security model, an authenticated user is deemed “safe” to interact with from an application perspective, having passed the technical security barriers.

The perimeter-based security architecture is effective until an unauthorized/malicious individual successfully “tricks” the application into believing they are a valid identity. The compromise of authentication credentials, e.g. phishing, social engineering, malware, and so forth, is a primary method utilized by malicious actors to gain access to networks, applications, and data. Once a malicious actor has penetrated a security perimeter they may continue to move through additional perimeters, i.e. lateral movement. The malicious actor has access to resources that the stolen credentials are entitled to, making thoughtful policy creation on a per-group/project basis crucial. Default configurations are often not changed and when policies are made by nontechnical users, they are not done so with least-privilege in mind. This leaves all responsibility of this task to system administrators who then have full unfettered access, which poses further risk when actors are successful in escalating their privilege.

One problem with traditional authentication and cybersecurity technologies dependent on them is the lack of context they have and the trust they place in single, non-confidence-based authentication of identities. The perimeter-based security model only provides applications with an authenticated identity. Additional authorization decisions may be made based on rules/policy when given the presented identity, but authentication fails to inform decision-making components of additional client-side state attributes (context). Perimeter-based security models and segmenting cybersecurity technologies leave the application ignorant of the environment it resides in, i.e. whether other components could have been compromised.

There have been several industry innovations in an effort to make identity and authentication technologies more resistant to exploitation. Standards and technologies have emerged to enable multiple factor (multi-factor) authentication possible. The general security model for authentication is based upon measures of difficulty. An entity must prove who they are based on some special knowledge, possession of a physical token, biometric features, and/or location features. The complexity inherent with each factor and the combination of multiple factors is presumed to strengthen the overall quality of authentication by making the barrier to impersonate (steal) an identity difficult. Even though multi-factor authentication technologies may raise the barrier for a malicious actor to impersonate an identity, it still does not prevent systems from exercising broad trust post-authentication.

Once past the authentication process it is up applications or some other cybersecurity technology to provide authorization functionality. Resource access decisions are made by who the authenticated identity is believed to be. The problem of trust in the layered cybersecurity model has not been addressed beyond making the authentication apparently less likely to be impersonated. There is no additional context provided, such as what factors were supplied to authenticate the user, where the authentication originated from (geolocation or network space), what device the authentication was performed on, and so forth. Nor do components themselves prove to each other they are still trustworthy (and thus the identities being passed between them are not compromised).

Applications and other defensive technologies can manage an authenticated identity via the logical construct of a session. Sessions can be shared among applications in a distributed architecture, e.g. for load balancing, segmentation, resource pooling, etc. The concept of a session provides limited context to components that are making authorization decisions. A session might include metadata that a process can utilize and may also be finite, i.e. expires at some future period. Authentication technologies that use session states often lack context of the authentication and also fail to challenge the continuous veracity of the authentication until it has expired. By not challenging the authentication of a user, especially where sessions are concerned, a system is vulnerable to a malicious actor impersonating an identity and/or stealing the underlying session of a valid user.

### SUMMARY

This section provides a general summary of the disclosure, and is not a comprehensive disclosure of its full scope or all of its features.

The present system overcomes the deficiencies of the prior known systems by using a system referred to herein as Null Trust Technologies (NTT). NTT takes advantage of strengthening the authentication process by enabling multi-factor methods such as passphrase, cryptographic token, smart card, lightweight directory access protocol (LDAP) and so forth. Additional context is added to the authentication process such that external system responsible for access control can be better informed about an identity when making access control decisions. Authentication data is independently verified by an external system that must be mutually authenticated with NTT. A standardized metric is calculated for each authentication request that scores the trust of the identity. The added contextual data along with the authentication metric enables more informed and granular policy/access control decisions.

Context provided by NTT drives decision processes of external systems with respect to authorizing requests from authenticated identities. Instead of relying on a session or blanket trust of a single layer (vertically)/perimeter (horizontally) of security, a system dynamically evaluates state information relative to the authentication context. For example, an authenticated identity that presents itself in one request as originating in a geolocated network space different from where the initial authentication occurred is an evaluation criterion subject for rejecting a potential malicious actor that stole a credential. The confidence metric calculated by NTT is also a criterion that becomes available for dynamic decision-making, i.e. authorizing a request is based on confidence in authentication not just the fact that it occurred.

Instead of relying on perimeter protections, the NTT system enforces segmentation between protected applications and client requests; it does not rely on other cybersecurity products and explicitly distrusts all traffic by default-even between processes inside a “safe” network perimeter. A perimeter guard intercepts client requests to applications transparently, without performing decryption, to verify whether they are authenticated and authorized. The perimeter guard is independent from the NTT authentication process to preserve the distrust-by-default security model. It must authenticate and re-validate its own state with the NTT authentication process. Clients authenticate directly to the NTT authentication process so that no other component is “in-the-loop” in case of malicious compromise.

The high level of segmentation between clients and applications minimizes the ability for a malicious actor with stolen credentials to move freely inside a perimeter. The reliance on trust inside a perimeter is minimized as each application and NTT security component is independent and must peer-authenticate themselves. Authentication context is preserved along the login chain allowing applications and other (validated) security components to make deeper authorization decisions to make it harder for a malicious actor to gain access to sensitive resources.

NTT overcomes the problems of traditional cybersecurity approaches to authentication and perimeter-based security measures. The security model of NTT components is such that there is always distrust to assure that every client request, software component, and network flow is segmented and independent of one another. This approach aims to prevent one piece of technology from being compromised and allowing it to be a launching point for malicious actors. In contrast to contemporary cybersecurity technologies and architectures, the NTT approach limits the ability for a malicious actor from causing harm by raising the difficulty in compromising credentials with default configuration while empowering applications to make more involved authorization decisions given enriched context.

NTT uses a multi-chain trust (MCT) approach for its authorization. This involves not one component (hardware/software), identity, or service trusting each other implicitly. Rather, entities must prove their identity to each other via certificates, over mutually authenticated transport layer security (TLS).

Specifically, the uniqueness of NTT is that clients do this process in two independent steps. First, with the core NTT server during authentication, which results in a token being created for the client if successful. Then, after completing the first step (the NTT TLS session ends), the client initiates a second TLS session with the perimeter guard to attempt to access a protected application (resource). During this second step, the cryptographic signature that is embedded in the received token from the first session is checked against the signature of this second session. If both match, then it is clear to the perimeter guard that the same client authenticated with NTT is originating this request. This protects against Token Hijacking, creating the first robust chain of trust. Once the token is verified, if MCT is enabled the perimeter guard will verify one of the original authenticators. By verifying with a 3rd party such as the PKI Certificate Infrastructure, the perimeter guard creates a second chain of trust not reliant on NTT (because this component is deployed and maintained by an entity different from NTT). These two steps can be thought of as two pathways, or chains of trust, each done independently, and then verified at a single location (client). If the two signatures do not match or 3rd party verification fails, then the client does not trust the perimeter guard and ends communications with it (token is invalid and login must be performed again).

Assuming the signatures match, the perimeter guard then uses the client token (from first step) to check its authorization policies with NTT. If the client's entity/identity should have access, the perimeter guard will then forward the client request for the resource to the resource's server; if not, the perimeter guard will send back a denial.

Although the MCT is optional for NTT it is an important design feature in the development of NTT. NTT uniquely implements this type of separation between deployment/ownership and verifications in a way that means more than one component of the system must be compromised at the same time, independently, to comprise authentication (and thus spoof identities).

The NTT authentication software component provides dynamic authentication functionality with enriched context to authorized software components, e.g. applications that themselves authenticate to NTT. The technology makes use of existing authentication mechanisms by allowing them to be chained in a multi-factor process. Outside of multi-factor authentication, NTT enforces cryptographic signature verification of all connections by way of mutually authenticated transport layer security (TLS). All connections that are transparently intercepted by the perimeter guard are forced to be encrypted and provide a peer certificate. A public key infrastructure (PKI) is required for NTT to function with multiple trust chains being possible, i.e. can support trusting multiple certificate authorities (CA). The forced encryption mitigates relying on other cybersecurity technologies to filter out connections and prevents applications from being vulnerable to a scenario where a malicious actor has breached a perimeter. The perimeter guard enforcement mechanism requires all clients to possess cryptographic signature credentials at a minimum making it more challenging for compromising credentials.

Once a client has authenticated to NTT, applications can incorporate the authentication context into authorization decision processes when granting clients access to data and other application functionality. The benefits of existing authentication technologies are leveraged by allowing any combination of factors to be provisioned by an administrator and for an entity to authenticate against. Instead of forcing a client to always maximally or minimally authenticate their identity, NTT makes the trust scalable from both ends of a session.

The NTT authentication process weighs the strength of authentication factors (authenticators) in a cumulative metric. The metric represents a confidence in not only the likelihood that the identity associated with the authentication is who they say they are, but also a measure of the difficulty in impersonating that identity, i.e. stealing credentials. Using this metric an application or other authorizing process may reject a client request for accessing a protected web resource when a threshold is not met or a new piece of client information changes with respect to the original authentication context, e.g. change in geolocation, network address, device identifier, etc. Presumably, the more sensitive a request is the higher trust in the authentication by the application or other authorizing process becomes.

Finally, another aspect of MCT that is present throughout all of NTT is the fact that all data is encrypted by default, using an MFA token (user is “in the loop”). If one component, such as perimeter guard is compromised the authentication requests sent through it would still be encrypted, meaning a man-in-the-middle attack could not be successful.

When an entity is a user or application contextual, composite authentication is used to steepen the barrier of impersonation and ensure that the elements that the authentication consist of were verified by different components of the overall NTT architecture (core authentication service, perimeter guard, application store/server, client-side application, and/or user token used for MFA).

More specifically, in one aspect of the disclosure, a system for accessing a protected web resource includes a client device communicating a client request toward the protected web resource, a perimeter guard system intercepting the client request and an authentication server. The client device initiates a first session between the client device and an authentication server. The authentication server authenticates the client device during the first session and in response to authenticating, associating an authentication token with a first cryptographic signature and communicating the authentication token to the client device. The client device initiates a second session with the perimeter guard system using the authentication token. The authentication server allows the client device to access the protected web resource based on the authentication token.

In another aspect of the disclosure, a method for accessing a protected web resource includes communicating, by a client device, a client request for accessing the protected web resource, intercepting the client request at a perimeter guard system, initiating a first session between the client device and an authentication server, authenticating the client device at the authentication server during the first session, in response to authenticating, associating an authentication token with a first cryptographic signature, communicating the authentication token to the client device, initiating a second session between the client device and the perimeter guard system using the authentication token and, based on the authentication token, allowing the client device to access the protected web resource.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a high level block diagrammatic view of the null trust technology system according to the present disclosure.

FIG. 2A is a high level block diagrammatic view of the perimeter of FIG. 1.

FIG. 2B is a flowchart of a method for generating a token and an accessor.

FIG. 2C is a flowchart of a method for establishing a session.

FIG. 2D is a high level flowchart of an authentication method with REST requests.

FIG. 3 is a high level method for authenticating the perimeter guard.

FIG. 4 is a more detailed block diagrammatic view of the NTT server.

FIG. 5 is a block diagrammatic view of the client device.

FIG. 6 is a high level flowchart of a transparent enforcement process according to the present disclosure.

FIG. 7 is a flowchart of the authentication process relative to the login metric.

FIG. 8 is a high level flowchart of a method for generating and storing tokens.

Corresponding reference numerals indicate corresponding parts throughout the several views of the drawings.

### DETAILED DESCRIPTION

Example embodiments will now be described more fully with reference to the accompanying drawings.

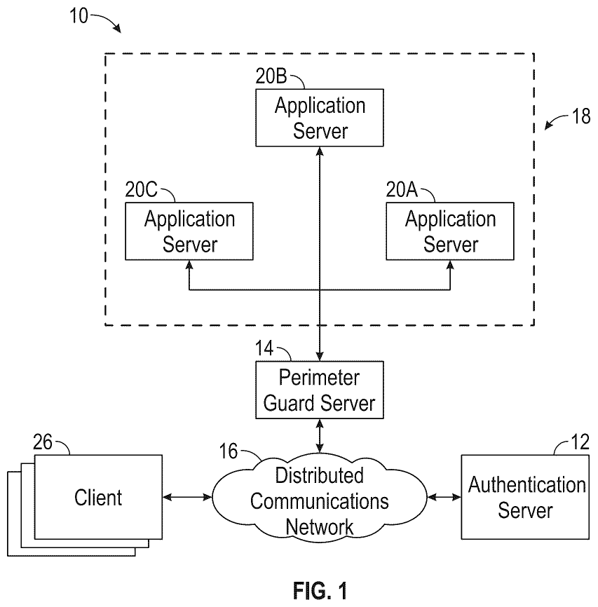

Referring now to FIG. 1, the system 10, referred to herein as a Null Trust Technologies (NTT) system 10 has an authentication server 12 and a perimeter guard server or simply perimeter guard 14 that are implemented on separate instances that are separated and intercommunicate through a distributed communication network 16. The perimeter guard 14 may be implemented on a separate server such as an application server or another type of device performing the functionality described below. The perimeter guard 14 may be another type of device not limited to an API gateway, a database, a hardware firewall a zero trust policy enforcement point. The communication network 16, although illustrated as a single entity, may be implemented in one or more types of networks including but not limited to wired or wireless networks, the Internet, cellular phone systems, satellite communication systems, a local area network (LAN), a wide area network (WAN) and a corporate intranet. The authentication server 12 and perimeter guard 14 have functionality that is independently executed.

The system 10 includes at least one protected web resource 18 that includes at least one application server. The perimeter guard 14 may be incorporated within an application server directly or as a library or sub process rather than a stand-alone component. The protected web resource 18 may have a security level that requires certain multi-chain security score in order to access. In the alternative, the protected web resource may include different types of data that each have a security level. Each type of data may require at least a certain score to access.

Three application servers 20A, 20B and 20C are illustrated by way of example. Fewer or more application servers may be provided in the system 10.

Client devices 26 are illustrated in the system, each of which act independently and therefore may be referred to in the singular below. The client device 26 attempts to access the protected web resources 18 and, more specifically to at least one of the application server 20A-20B initiated through an application stored within the client device 26 as described below. The client device 26 is in communication with the perimeter guard 14 and the authentication server 12 through the network 16.

In the security model of the NTT system 10, no component relies on or trusts other cybersecurity products to mitigate vulnerabilities and improve security compared to prior known systems. The individual components of the system 10 are configured to distrust every client request and network host until the components have proven themselves to be trustworthy in a continuous manner, e.g., by repeatedly checking after a predetermined configuration time period, such as every 15 minutes. The components are compiled into a binary distribution that is executed on a server.

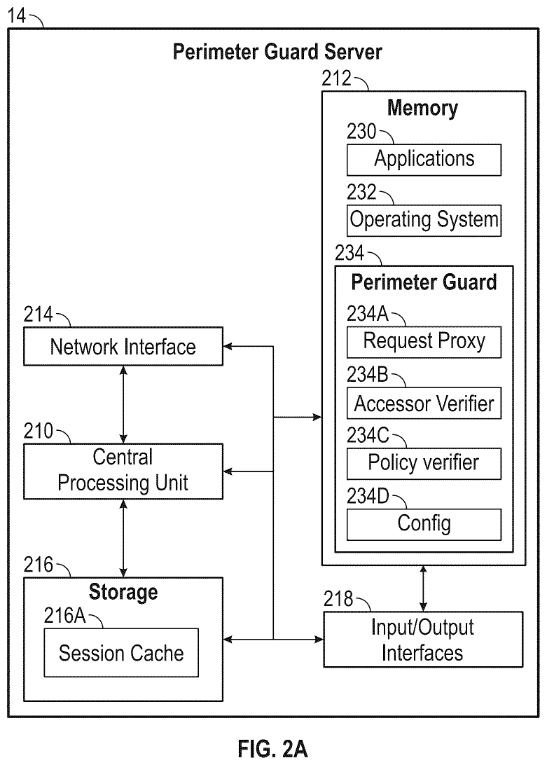

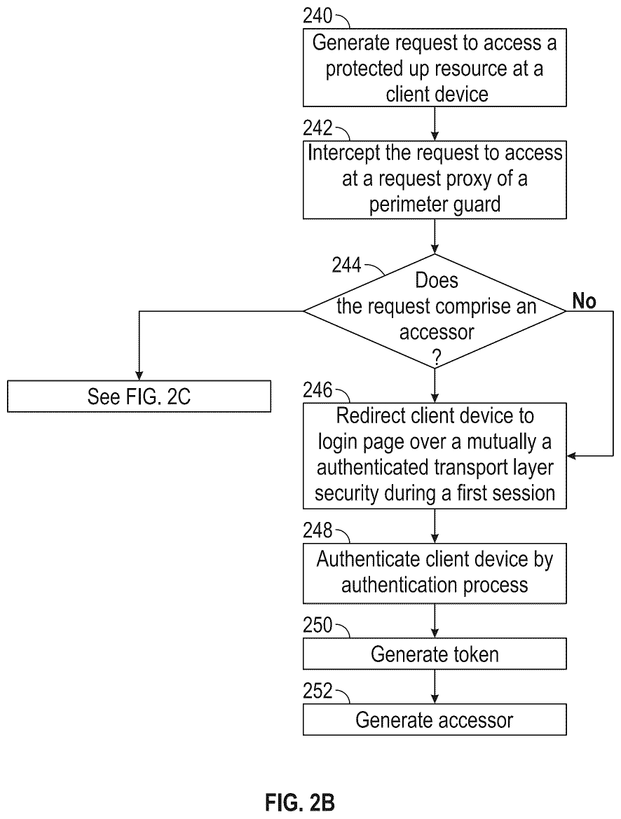

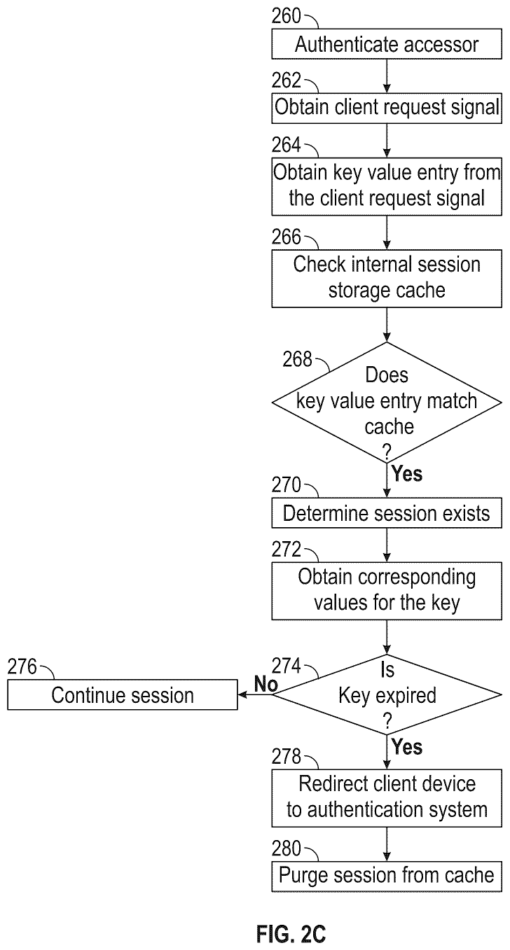

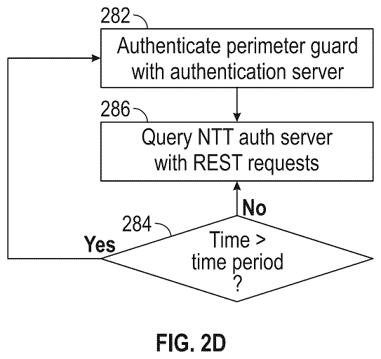

Referring now also to FIG. 2A, the perimeter guard may be implemented as a stand-alone perimeter guard server 14 that has a central processing unit (CPU) or processor 210, a random access memory (RAM) 212, a network interface 214, and volatile storage 216 and an input/output interface 218. The processor 210 is microprocessor-based. The memory 212 is a non-volatile computer readable medium that stores machine readable instructions that are executable by the processor 210. The machine readable instructions include instructions for implementing allocated functions of the system 10. The memory 212 stores code for the functions including an application 230, an operating system (OS) 232, and a perimeter guard system 234. The operating system 232 coordinates the input/output interfaces 218 of the hardware resources, and executes the perimeter guard system 234, The perimeter guard server 14 can be a physical device with dedicated hardware or can be a virtual machine that shares a part of dedicated hardware resources, e.g. a hypervisor.

The perimeter guard system 234 has a request proxy handler 234A, and access verifier 234B, a policy verifier 234C, and a configuration 234D. The operation of the perimeter guard system 234 and the components thereof 234A-234D are described in greater detail below.

Referring now also to FIG. 2B, a method for operating the perimeter guard server 14 is set forth. The method begins when a request to access a protected web resource is generated by a client device 26. The request proxy handler 234A of the perimeter guard system 234 processes all incoming and outgoing hypertext transfer protocol (HTTP) web application traffic. To enforce security, all HTTP traffic destined for an application server 20 is blocked or denied by the perimeter guard 234 and verified against a session store. Blocked or denied means that the web address for the protected web resource in the request is changed to the address of perimeter guard. Depending on the authorization, the perimeter guard routes the request to the appropriate destination as described in greater detail below. When no authorization is present, such as not token, an HTTP redirect signal is used to route the requesting device to the authentication server.

The request proxy handler 234A starts by looking for special cookies and/or request headers in the inbound HTTP request sent by clients. The value of the header and/or cookie are the unique identifiers, known as accessors, which are used to lookup sessions in the perimeter guard accessor verifier 234B. In step 244 it is determined whether a token accessor or simply accessor is present in the request. Should these expected pieces of information not be found in a request from a client in step 244, the perimeter guard 234 redirects the request to the login webpage of the NTT authentication server in step 246 marking a complete hand-off, i.e., no longer in the middle of the connection, signaling a user must perform authentication in step 248. Thus, a first session is initiated.

The NTT authentication process starts by initiating the first session and results in two pieces of information critical to a client. The first is the cryptographic token that is generated in step 250 and the second is the accessor generated in step 252, that aliases the cryptographic token, i.e. it cannot reveal the token contents but is a reference pointer in an NTT authentication token storage component. A cryptographic token is a token with a cryptographic signature. As mentioned above, the non-sensitive accessor is sent by the client to the perimeter guard server 14 as a session token, and the perimeter guard accessor verifier 234B is responsible for verifying that the accessor is valid with the NTT authentication server 12.

Referring now to FIGS. 2A and 2C, the perimeter guard 234 authenticates and reauthenticates itself periodically with the NTT authentication server 12 in step 260 to allow the perimeter guard server 14 to have access to the authentication server 12 because the system overall is intentionally untrusting.

The accessor verifier 234B of the perimeter guard 234 receives a request signal at step 262 and, in step 264 obtains a key value entry by first checking an internal session storage cache 216A for the existence of a session in step 266. When the key value matches the value in the session cache 216A in step 268, step 270 determines a session was initiated. A session is represented by key-value entry, where the key is the accessor sent by the client as a cookie and/or in a request HTTP header. In step 272, the corresponding data values for a key (accessor) are obtained. The data structure that holds essential metadata or other authentication context, e.g. expiration time, username, authentication metric, policies, geolocation, internet protocol (IP) address, etc. Should a session be found by the provided key, step 274 determines whether the expiration time has been reached or exceeded. If the session is valid, the session continues in step 276. If the session is invalid based on expiration time, the client request is redirected to the NTT authentication server 12 in step 278 and the session is purged from the cache in step 280. The session cache is periodically cleaned by expiring all sessions whose key will no longer work outside of client request triggers.

Referring now to FIG. 2D, step 260 is described in greater detail, the accessor verifier 234B of perimeter guard 234 as mentioned above must authenticate itself to the NTT authentication server 12 to validate client device-provided accessors. The authentication process is performed outside the perimeter guard's context, so it is capable of looking up client identity information. As the security model of NTT distrusts all components by default, the accessor verifier 234B and the NTT authentication server 12 are mutually authenticated with a machine TLS certificate and cryptographic token. The perimeter guard 234 continuously authenticates itself in step 282, e.g., by authenticating repeatedly once during each predetermined time period such as fifteen minutes as indicated in step 284, with the authentication component 12, as its own credentials are finite and/or can be revoked. Once authenticated, the accessor verifier 234B queries the NTT authentication server 12 using HTTP web application representational state transfer (REST) requests according to an application programming interface (API).

Both affirmative and negative responses may be provided to the accessor verifier 234B with respect to the status of a client's authentication. Should a negative response be provided, the client is redirected back to the NTT authentication server 12 and will continue to do so until the client successfully authenticates. A new entry is created in the accessor verifier 234B session cache for a validated accessor.

The accessor verifier 234B of perimeter guard 234 then performs a comparison of cryptographic signatures used during the client request to the perimeter guard to the cryptographic signatures used when the session was initiated with the NTT server 12. If MCT is enabled one of the original factors presented to the NTT server 12 during session initiation is verified by perimeter guard system 234 with a third-party authentication system, such as a password, LDAP, time-based one-time password (TOTP), PKI (token-based) or active directory; this third party is configurable and can be any service. If the two match in identity, then the multiple chains of trust (MCT) pass verification and the perimeter guard performs its lookup (via accessor/token verification component) on affiliated policies; if the two do not match the perimeter guard delivers a redirect for authentication (login). These cryptographic signatures are usually signed X509 digital certificates but could be any other form, such as a SHA256 hash. The MCT components are described in greater detail below.

Revocation of the client's cryptographic token necessarily destroys the authentication session. The NTT authentication server can communicate these revoked accessors with the perimeter guard based on the API. The accessor verifier 234B periodically polls for revoked accessors and synchronizes its session cache. Optionally, real-time pushes to the perimeter guard are possible from the authentication server regarding revocation actions in a publish-subscribe message pattern.

Referring back to FIG. 2A, a policy verifier 234C of the perimeter guard 234 receives request context from the perimeter guard following the verification of a client's authentication status. The policy verifier 234C compares policies that have been provided from the authentication context to an expected policy list for a given protected application. The authorization step enforces policy constraints that the client has been assigned when it authenticated to the NTT authentication server. Should a policy be missing that is required, the client is returned an access denied response—but not redirected to the login webpage as it is already authenticated. The client is left to handle the error by re-authenticating with necessary factors and policies needed to gain access to the application.

The request proxy handler 234A forwards the authenticated and authorized request to the intended application. The perimeter guard 234 responds on behalf of the application server for all responses destined for the client. This behavior continues until the session has expired or been revoked.

The configuration component 234D is used by the perimeter guard 234 to keep track of application servers and authorization policies. The configuration component 234D registers the network location, e.g. hostname and port, that the application server is listening on. Authorization rules that govern policies and/or other authentication context attributes that are necessary to access an application are submitted to and loaded by the configuration component. The configuration live-updates the perimeter guard requiring no restarting of the software process.

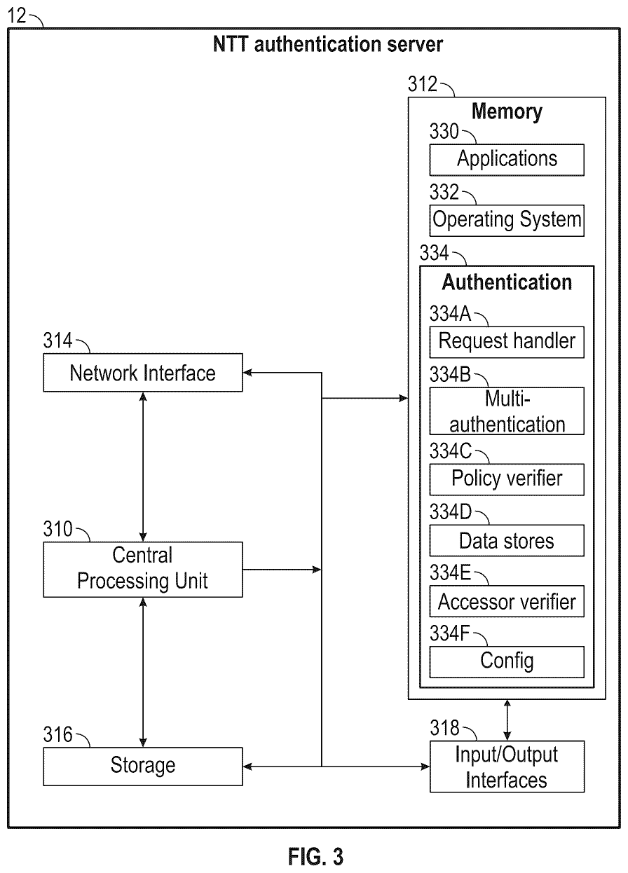

Referring now also to FIG. 3, the authentication server 12 has a central processing unit (CPU) or processor 310, a random access memory (RAM) 312, a network interface 214, and volatile storage 316 and an input/output interface 318. The processor 310 is microprocessor-based. The memory 312 is a non-volatile computer readable medium that stores machine readable instructions that are executable by the processor 310. The machine readable instructions include instructions for implementing allocated functions of the system 10. The memory 312 stores code for the functions including an application 330, an operating system (OS) 332, and an authentication system 334. The operating system 332 coordinates the input/output interfaces 318 of the hardware resources and executes the authentication system 334. The authentication server 12 can be a physical device with dedicated hardware or can be a virtual machine that shares a part of dedicated hardware resources, e.g. a hypervisor.

The authentication system 334 has a request handler 334A, a multi-authentication component 334B, a policy verifier 334C, data stores 334D, an access verifier 334E and a configuration 334F. Details of the operation of the authentication system 334 including the operation of the components 334A-334F are set forth below.

The system 10 has the protected web resources 18 such as protected application instances or databases that are transparently proxied by the perimeter guard system 234 of the perimeter guard server 14. The perimeter guard system 234 listens on its network interface 214 for requests. By proxying requests the perimeter guard server 14 is the only exposed network interface between the client devices 26 and applications running on server instances. The network should be segmented logically between external, client-accessible networks and internal application server accessible networks, effectively becoming a Layer 5 Application firewall. Additionally, the perimeter guard server 14 acts as a load balancer forwarding incoming client requests to different application servers according to a selected connection-balancing strategy. The domain name system (DNS) hostname that an application is reached by aliases (points to) the perimeter guard. Client devices 26 are assumed to be capable of resolving the application hostname(s) and have network connectivity to the perimeter guard.

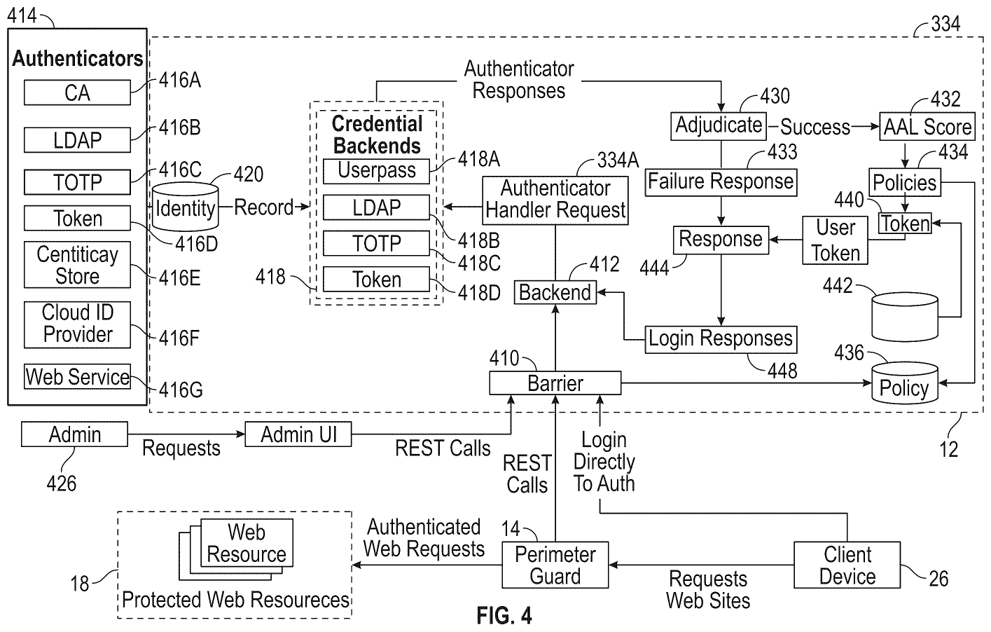

Referring now also to FIG. 4, the NTT authentication system 334 is illustrated in greater detail in the authentication server 12 provides functionality to perform dynamic multi-factor authentication. The authentication system 334 is part of the on the NTT authentication server 12 that utilizes a request handler 334A for responding to client requests sent to the 12 server through the network interface 314. The request handler 334A responds to HTTP web application REST requests governed by a defined API or barrier 410.

The request handler 334A obtains a TLS peer certificate from the access request signal. Through a backend 412. The certificate is not verified by the request handler 334A but instead is passed to other server components such as the multi-authentication component 334B that will validate the certificate based on authenticator 414 such as trusted certificate authorities (CAs) 416A. Other connection context data, such as IP address, hostname, user agent string, headers, referrer, etc. are passed to components that make use of the data for policy decisions and/or providing authentication context.

Authenticators 414 may be third party operated external systems that can be used to authenticate a request for accessing the web resource 18 from the client device 26. When an authentication request is initiated by the client device 26 through the request handler 334A, the multi-authentication component 334B references provisioned the authenticators 414 to proxy authenticate the client request based on provided factors. The client device 26 makes an authentication request that comprises at least some of a username, password, and additional factors that are desired to achieve a higher authentication metric. Additional factors may be hardware or software time-based one-time password (TOTP) tokens, additional memorized secrets to be provided to a specific authenticator, or other cryptographic hardware/software secrets.

The multi-authentication component 334B has a credential backend 418 that comprises a plurality of backends 418A-D. The plurality of backends 418A-D in this example comprises a user password back end 418A, an LDAP backend 418B, a TOTP backend 418C and a PKI or token backend 418D. Of course, a greater number or fewer individual backends 418 may be provided. The backends 418 interface with individual authenticators 414 that may be owned and operated independently from each other and the operator of the system 10. The multi-authentication component 334B that performs verification of the client TLS peer certificate in the request to access the web resource 18. The peer certificate is required for authentication to proceed otherwise the client device 26 is denied access regardless of the disposition of other provided factors. The client certificate common name (CN) must match the client provided username as determined using the identity database. This ensures a malicious actor cannot compromise another user's peer certificate to supply with a non-matching credential. The peer certificate is fingerprinted using a one-way hash function. The certificate hash is stored as authentication context such that only the same TLS peer certificate that was used with the authentication request must be used with requests via the perimeter guard or other protected application(s). Enforcing peer certificate use mitigates the vulnerability of cross-site scripting and cross-site request forgery attacks that can result in the compromise of cookies/tokens. The peer certificate must be issued by a trusted CA, must not have been revoked, and must be currently valid given the expiration date in order to satisfy the peer TLS check.

The multi-authentication component identity database 420 can itself be used as an authenticator storing a salted user password. The username provided by a client in the authentication request is the primary key for looking up authenticators and other necessary authentication data. An administrator 426 provisions authenticators and associates a record with each user in the multi-authentication component's identity database 420. The record of the authenticators 414 is a pointer to another source of identity/authentication such as the certificate authority 416A, lightweight directory access protocol (LDAP) provided 416B, TOTP provider 416C, a PKI or token provider 416D, certificate store 416E, a cloud identity provider 416F, and other web services 416G that can authenticate clients. Each authenticator 414 may be provisioned for the user device and may require specific factors that are governed by the API when clients are building the authentication request payload.

The multi-authentication component 334B attempts authenticating against each authenticator backend 418 or authenticator 414 for which the client device provided a username. Each authenticator 416A-416G is independent and is used to generate a baseline score that is communicated to an adjudicate component 430 that contributes to the authentication metric that is calculated and stored as a context. The more factors provided by the client device (assuming success), as well as higher-assurance authenticator, results in a stronger metric. The adjudicate component 430 communicates the baseline scores to a score generator 432 to generate a weighted authentication score. The weighted authentication score may be generated per the NIST 800-63b standard. The higher the authentication score the more likely it is that the client device is who they say they are and the more difficult it is to impersonate the authentication request. Should a factor be provided and fail to authenticate then the entire authentication fails for the client request at the failed response block 433, even if another factor has passed.

A policy component 434 applies to the authentication context according to each client device. Administrators assign allowed policies to a user/client device in a multi-authentication policy database 436. Should the requesting client device not be entitled to a requested policy the authentication request will be denied. The policies are stored with the authentication context such that they can be used by other authorization components such as the perimeter guard or an application. The client specification of policies is meant to enforce a “least privilege” principle to mitigate the breadth of access a stolen token/authenticator can provide to a malicious actor.

The policy component 434 stores policies and other rules that an authentication context must satisfy in order for authentication to be granted a policy. The policy is stored in the database 436 by name, with additional policy data stored in reference to the named policy. The authentication request by a client is validated against a user's right to request a policy and the required criteria for granting access to the policy, e.g. network condition, geolocation, device identifier, time of day, and so forth. Each database that a component maintains utilizes the datastore component as a generic repository for persisting relationships in a key-value manner. All data in the datastore component is encrypted at-rest requiring explicit administrative decryption before becoming available to other components. The datastore is protected from arbitrary offline access by malicious actors.

The final result of the multi-authentication component is a response 444 which is either an access denied response that gets forwarded back to the client via the request handling component or a cryptographic user token 446 that is generated at the token processor 440 and is stored with authentication context in the datastore component. Assuming a successful authentication has occurred, the generated cryptographic token value, an accessor unique identifier, expiration time, and full authentication context metadata are stored in a database that tracks outstanding/valid tokens. The database 442 periodically checks the state of tokens and revokes them (delete operation) when expired. Authorized administrators or clients may revoke tokens at any time. Login responses 448 corresponding to whether a token is present in a first session may also be returned.

The request handler 334A responds to the client's authentication request with data that is used to traverse the perimeter guard 14 and access applications. Clients store sensitive data in their web browser context that is trusted to enforce the security of the data via single document object model (DOM) restrictions. The data is useful for the length of the authentication, i.e. until the expiration date is passed, or until the token has been revoked, whichever comes first.

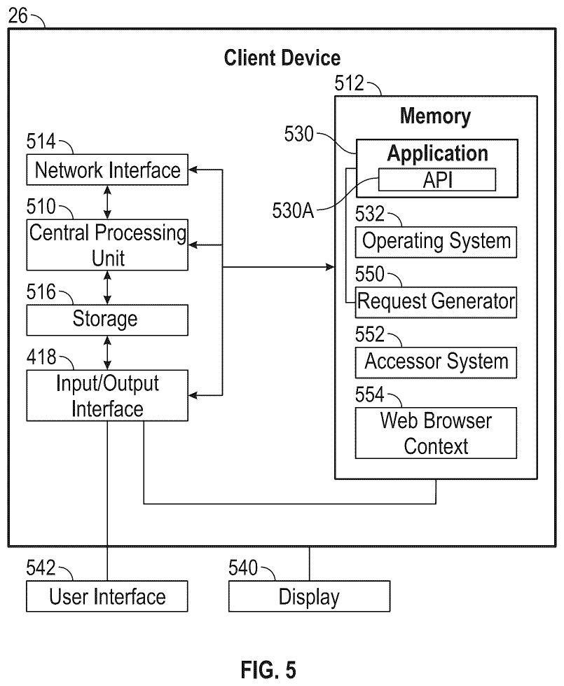

Referring now to FIG. 5, the client device 26 has a central processing unit (CPU) or processor 510, a random access memory (RAM) 512, a network interface 514, and volatile storage 516 and an input/output interface 518. The processor 510 is microprocessor-based. The memory 512 is a non-volatile computer readable medium that stores machine readable instructions that are executable by the processor 510. The machine readable instructions include instructions for implementing allocated functions of the system 10. The memory 512 stores code for the functions including the application 330 with an application interface (API) 530A and an operating system (OS) 532. The operating system 532 coordinates the input/output interfaces 518 of the hardware resources and executes the application 530. The client device 26 may be a mobile device.

The client device 26 has a display 540 and a user interface 542 associated therewith. The user interface 542 may include a keyboard, a mouse, a touchscreen and the like. The user interface 542 may also include a fingerprint sensor and a camera for inputting security identifiers or data. The user interface 542 may be used to input various information. The display 540 is used to display various data from the application 530. The user interface 542 together with the display 540 may allow the user of the client device 26 to interact with the application 530.

Memory 512 may also have code to perform requests at a request generator 550. The memory 512 now also includes code to provide an accessor system 552 to provide accessor into the request. A web browser context 554 may be used to store sensitive data as mentioned above. The client device 26 is capable of communicating over distributed communications infrastructure such as the network 16.

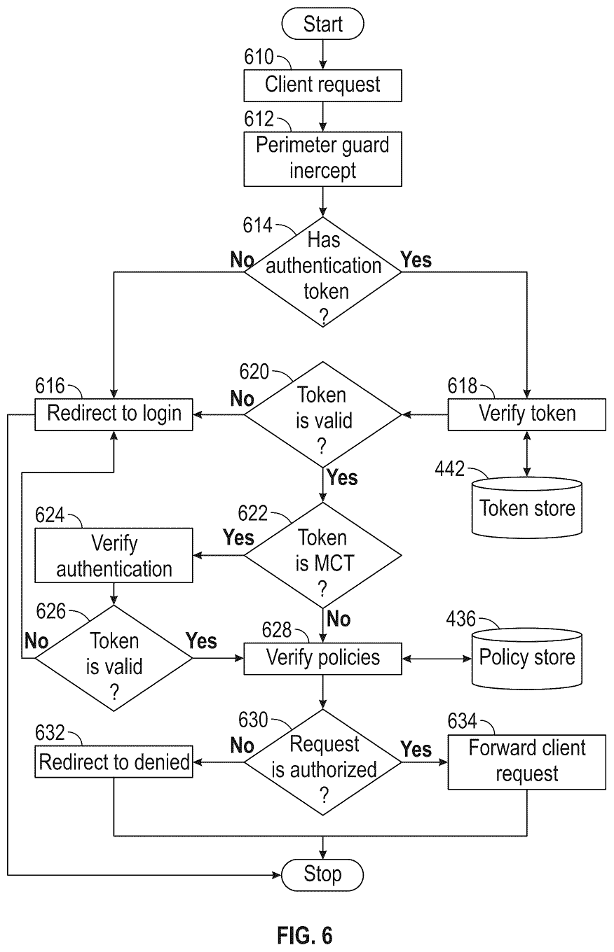

Referring now to FIG. 6, a high level summary flowchart of the operation of the system 10 is set forth. The authentication system 334 and the perimeter guard system 234 run on respective servers 12, 14 and listen for requests to access a protected web resource 18 in step 610 such as from the client device 26 though the network interfaces 214, 314. Communication over the network 16 between the NTT components and clients is governed by the internet protocol suite-referred to as transmission control protocol/Internet protocol (TCP/IP). The operating system 332 handles the underlying communication segmentation transparently. The server software components are only concerned about the application layer.

To enforce security, all HTTP traffic destined for an application server 20 is intercepted by the perimeter guard 234 in step 612.

As mentioned above, the perimeter guard intercepts all the communication that is bound for a protected web resource. The request in step 614 is monitored to determine whether an authentication token is provided. When an authentication token is not provided to the perimeter guard in the request, the request handler 334A directs the request and therefore client device to the authentication server 12 where a session is initiated.

Referring back to step 614, when an authentication token is present in the request, step 618 verifies the token by initiating a second session. The token may be verified by comparing the token to the token database using the token processor 440. After steps 618, step 620 determines whether the token is valid. If the token is not valid, step 616 redirects the request to a login web page of the authentication server 12 where a session may be initiated. In step 620 is valid, an optional step of performing multi-chain trust (MCT) may be performed in step 622. If the token is a multi-chain trust token, step 622 verifies the token with a plurality of independent authenticators which are from a third party. As mentioned above, the request handler 334A routes the request through the credential backends 418A-D which are in communication with one or more authenticators 414 as mentioned above. After the authenticators are verified in step 624, it is determined whether a token is valid in step 626. If a token is not valid in step 626, step 616 reroutes the request to the authentication server 12.

Referring back to step 622, when the token is not a multi-chain authentication token, step 628 verifies the policies. Steps 628 is also performed after step 626 when a token is valid. Policies may be obtained from the policy database 436. The policies may be provided based upon a name associated with the token. Likewise, as mentioned above, various levels of security for different types of protected web resources 18 may be provided. Thus, the level of security may be a score as generated in the score generator 432 as mentioned above. Different portions of a protected web resource may be available with low securing that corresponds to a low security while others may require a high security score. After step 628, step 630 determines whether the request is authorized. If the request is not authorized, the client device may be redirected to a web page (e.g., a 404 web page) announcing access was denied in step 632. In step 630, when the request is authorized, the client request and therefore the client device is forwarded to the protected web resource.

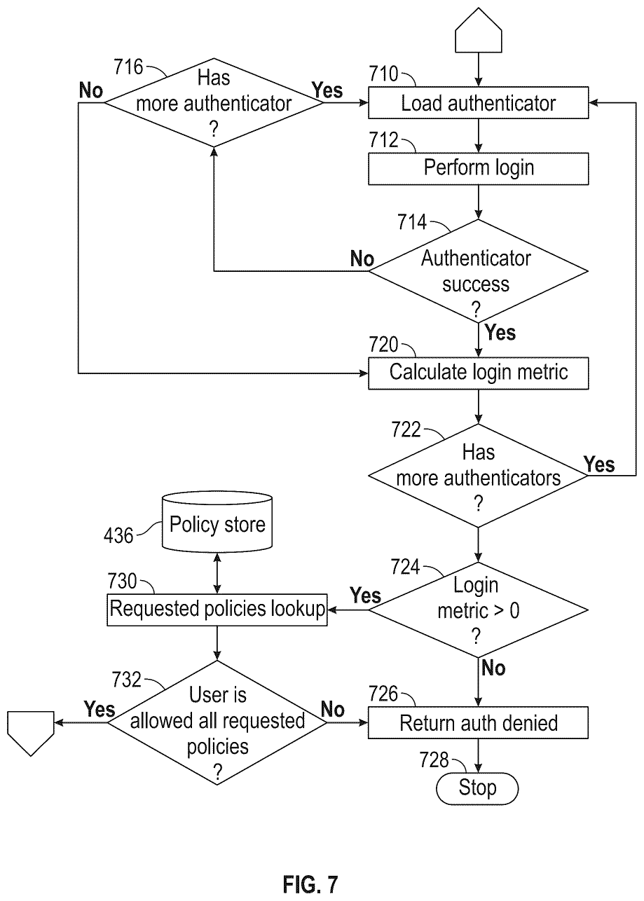

Referring now to FIG. 7, the multi-chain trust authentication process is provided. In step 710, the authenticator is loaded into the credential back end 418. In step 712, a login is performed. When the login is performed, it is determined whether the authentication within the login has been successful in step 714. The system may log into all of the different authenticators for the multi-chain authentication in step 712. When the authentication is not a success in step 714, the system determines whether more authenticators are present. If more authenticators are present, steps 710-714 are performed for each of the authenticators.

When the authentication is successful, step 720 calculates a login metric at the adjudicate component 430. The login metric is performed for each of the authenticators. Therefore, after step 720, when more authenticators are present in step 722, step 724 determines whether the login metric is greater than 0. When the login metric is not greater than 0, step 726 denies authorization to the request and the system stops in step 728.

Referring back to step 724, when the login metric is greater than 0, the requested policies are looked up from the database 436 in step 730. After step 730, step 732 determines whether the user is allowed all requested policies. As mentioned above, the level of security for different types of web resources may be monitored. That is, the security level of a requested resource may be compared to the score from the score generator 432 to determine whether the web resource 18 is allowed to be accessed.

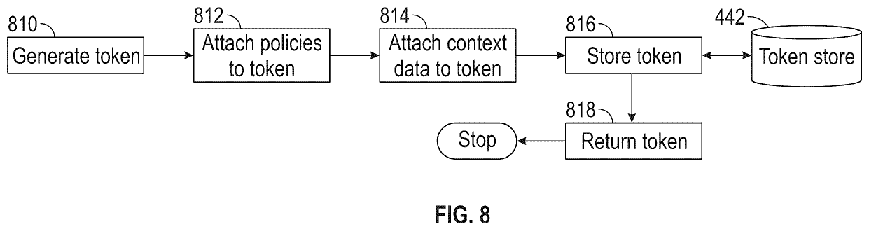

Referring now to FIG. 8, a system for associating the token with the user is set forth. In step 810, a token is generated. The token may be generated in the token generator 440. In step 812, policies associated with the user are attached to the token. Likewise, context data 814 is also attached to the token. The token is stored in the database 442 at step 816 along with the context data and policies. The policies may be stored in a policy database 436 and may be stored in the token database 442.

After step 816, the token is returned to the user device in step 818.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements.

The phrase “at least one of A, B, and C” should be construed to mean a logical (A OR B OR C), using a non-exclusive logical OR, and should not be construed to mean “at least one of A, at least one of B, and at least one of C.” The term “set” does not necessarily exclude the empty set. The term “non-empty set” may be used to indicate exclusion of the empty set. The term “subset” does not necessarily require a proper subset. In other words, a first subset of a first set may be coextensive with (equal to) the first set.

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. Such apparatuses and methods may be described as computerized apparatuses and computerized methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A method for accessing a protected web resource comprising:
communicating, by a client device, a client request for accessing the protected web resource;
intercepting the client request at a perimeter guard system;
initiating a first session between the client device and an authentication server;
authenticating the client device at the authentication server during the first session;
in response to authenticating, associating an authentication token with a first cryptographic signature;
communicating the authentication token to the client device;
initiating a second session between the client device and the perimeter guard system using the authentication token; and
based on the authentication token, allowing the client device to access the protected web resource.

2. The method of claim 1 wherein prior to initiating the first session, redirecting the client device to the authentication server disposed separately from the perimeter guard system when an authentication token is not present in the client request.

3. The method of claim 1 wherein intercepting is performed at a request proxy of the perimeter guard system.

4. The method of claim 1 wherein initiating a second session comprises initiating a second session having a second cryptographic signature and wherein allowing the client device to access the protected web resource comprises allowing the client device to access based on comparing the first cryptographic signature and the second cryptographic signature.

5. The method of claim 1 wherein initiating a second session comprises initiating a second session comprising a second cryptographic signature and comparing the first cryptographic signature and the second cryptographic signature, wherein the first cryptographic signature and the second cryptographic signature matches.

6. The method of claim 1 wherein during the second session, generating the authentication token comprises generating a score and allowing the client device to access the protected web resource based on the score.

7. The method of claim 6 wherein generating the score comprises generating a score based on a plurality of authenticators.

8. The method of claim 6 wherein generating the score comprises generating a score based on a plurality of authenticators independent from the authentication server.

9. The method of claim 6 wherein allowing the client device to access the protected web resource comparing the score to a level of security.

10. The method of claim 1 wherein during authenticating, generating the authentication token comprises determining a policy and associating the policy with the authentication token.

11. The method of claim 1 wherein generating the authentication token comprises generating a token accessor.

12. The method of claim 11 wherein the token accessor comprises a header or a cookie.

13. The method of claim 11 wherein generating authentication token comprises aliasing the authentication token using the accessor.

14. The method of claim 10 wherein aliasing comprises aliasing the authentication token by pointing to a credential backends without revealing token contents.

15. The method of claim 1 wherein initiating a first session comprises forming a first mutually authenticated transport layer security (TLS) session and wherein initiating a second session comprises forming a second mutually authenticated transport layer security (TLS) session.

16. A system for accessing a protected web resource comprising:
a client device communicating a client request toward the protected web resource;
a perimeter guard system intercepting the client request;
an authentication server separated from the perimeter guard system;
the client device initiating a first session between the client device and an authentication server;
the authentication server authenticating the client device during the first session and in response to authenticating, associating an authentication token with a first cryptographic signature and communicating the authentication token to the client device;
the client device initiating a second session with the perimeter guard system using the authentication token; and
the authentication server, allowing the client device to access the protected web resource based on the authentication token.

17. The system of claim 16 wherein the authentication server is disposed separately from the perimeter guard system, the client device being redirected to the authentication server.

18. The system of claim 16 wherein the client device initiates a second session having a second cryptographic signature and wherein the authentication server allows the client device to access the protected web resource based on comparing the first cryptographic signature and the second cryptographic signature.

19. The system of claim 16 wherein during the second session, generating the authentication token comprises generating a score and allowing the client device to access the protected web resource based on the score.

20. The system of claim 19 wherein the score is based on a plurality of independent authenticators.

21. The system of claim 20 wherein the authentication server allows the client device to access the protected web resource based on comparing the score to a level of security.

22. The system of claim 16 wherein the authentication server associates a policy with the authentication token and the authentication server allows access to the protected web resource based on the policy.
